(19) United States
(12) Patent Application Publication
(10) Pub. No.: US 2008/0101379 A1
(43) Pub. Date: May 1, 2008

(54) Atm Witched Router for Transmitting Ip Packet Data

(75) Inventor: Jung Hee Park, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/585,586

(22) PCT Filed: Jan. 14, 2005
(86) PCT No.: PCT/KR05/00133

§ 371 Date: Jun. 15, 2007

(30) Foreign Application Priority Data
Jan. 15, 2004 (KR) 10-2004-0002981

(51) Int. Cl. H04L 12/56

(52) U.S. Cl. 370/395.53

(57) ABSTRACT

The present invention generally relates to a switch router for use in a High-speed ATM Multi-service Switching system (HAMS), and more particularly to a switch router for transmitting IP packet data comprising: a Switch Link Assembly (SLA) for switching ATM packet data inputted from a higher block to an IP Forwarding Control Assembly (IFCA), the SLA further being operative to switch the ATM packet data inputted from the IFCA to the higher block; an IFCA for routing the ATM packet data inputted from the SLA to an EtherNet Link board Assembly (ENLA), the IFCA further being operative to route the ATM packet data inputted from the ENLA to the SLA; and an ENLA for converting the ATM packet data routed from the IFCA to an Ethernet data and transmitting the Ethernet data to the higher block, the ENLA further being operative to convert the Ethernet data inputted from the higher block to a local ATM packet data and output the local ATM packet data to the IFCA.

### TECHNICAL FIELD

The present invention generally relates to a switch router for use in a High-speed ATM Multi-service Switching system (HAMS), and more particularly to a switch router for use in HAMS, wherein the constituents of the switch router are connected through ATM paths and the transmission of IP packet data is enabled.

### BACKGROUND ART

FIG. 1 is a functional block diagram showing the configuration of the conventional switch router for use in the HAMS. Referring to FIG. 1, the conventional switch router comprises EtherNet Link board Assembly (ENLA) 1 and IP Forwarding Control Assembly (IFCA) 2. However, the technical level of the conventional switch router remained at the stage of merely testing the functions of ENLA 1 and IFCA 2. In addition, ENLA 1 and IFCA 2 failed to function completely and in such case, only the devices within ENLA 1 and IFCA 2 could be verified.

This limited the verification of the path between ENLA 1 and IFCA 2. Thus, the testing of the substantial Ethernet service function was restricted.

FIG. 2 is a functional block diagram showing the detailed configuration of the conventional switch router for use in HAMS. Referring to FIG. 2, the conventional switch router comprises ENLA 1 for switching Ethernet data and IFCA 2 for routing. ENLA 1 comprises switching hub 11 and Segmentation and Reassembly device (SAR) 12, while IFCA 2 comprises SAR 21 and CPU 22. In this switch router, LAN cable is utilized to couple the constituents.

As shown in FIG. 2, the Ethernet data is inputted to switching hub 11 in ENLA 1 via the node. It is then transmitted to SAR 21 in IFCA 2 via SAR 12. The Ethernet data is then routed by CPU 22 in IFCA 2 and transmitted back to SAR 12 in ENLA 1 by SAR 21.

Then, the Ethernet data is transmitted to the other switching hub 11 in the other ENLA 1 through SAR 12 and switching hub 11 in ENLA 1. The Ethernet data is then transmitted to the other CPU 22 via the other SAR 21 in the other IFCA 2. Meanwhile, regarding the communication within ENLA 1, ENLA 1 is capable of converting the Ethernet data into a local Asynchronous Transfer Mode (ATM) packet data.

The Ethernet data is then routed by the other CPU 22 in the other IFCA 2 and transmitted back to the other SAR 12 in the other ENLA 1 via the other SAR 21. The other SAR 12 in the other ENLA 1 then transmits the inputted Ethernet data to the node coupled to the other switching hub 11.

However, in the conventional switch router, the communication is established by transmitting and receiving Ethernet data only. Therefore, the communication speed should be low and the communication with ATM equipment is impossible.

### DISCLOSURE OF THE INVENTION

Therefore, the object of the present invention is to solve the above problems. In particular, the object of the present invention is to provide a switch router for use in HAMS, which couples the constituents through ATM paths and enables the transmission of IP packet data. This provides a faster communication service compared to the conventional switch router.

In order to achieve the above objects, the present invention provides a switch router for transmitting IP packet data comprising:
an IFCA for routing the ATM packet data inputted from the SLA to an EtherNet Link board Assembly (ENLA), the IFCA further being operative to route the ATM packet data inputted from the ENLA to the SLA; and
an ENLA for converting the ATM packet data routed from the IFCA to an Ethernet data and transmitting the Ethernet data to the higher block, the ENLA further being operative to convert the Ethernet data inputted from the higher block to a local ATM packet data and outputting the local ATM packet data to the IFCA.

Further, the present invention provides a switch router for transmitting IP packet data, wherein the SLA, the IFCA and the ENLA are connected by fiber optic cable for use in ATM communication.

### BRIEF DESCRIPTION OF DRAWINGS

FIG. 1 is a functional block diagram showing the configuration of the conventional switch router for use in HAMS.

FIG. 2 is a functional block diagram showing the detailed configuration of the conventional switch router for use in HAMS.

FIG. 3 is a functional block diagram showing the detailed configuration of the switch router for use in HAMS, which enables the transmission of IP packet data, according to one embodiment of the present invention.

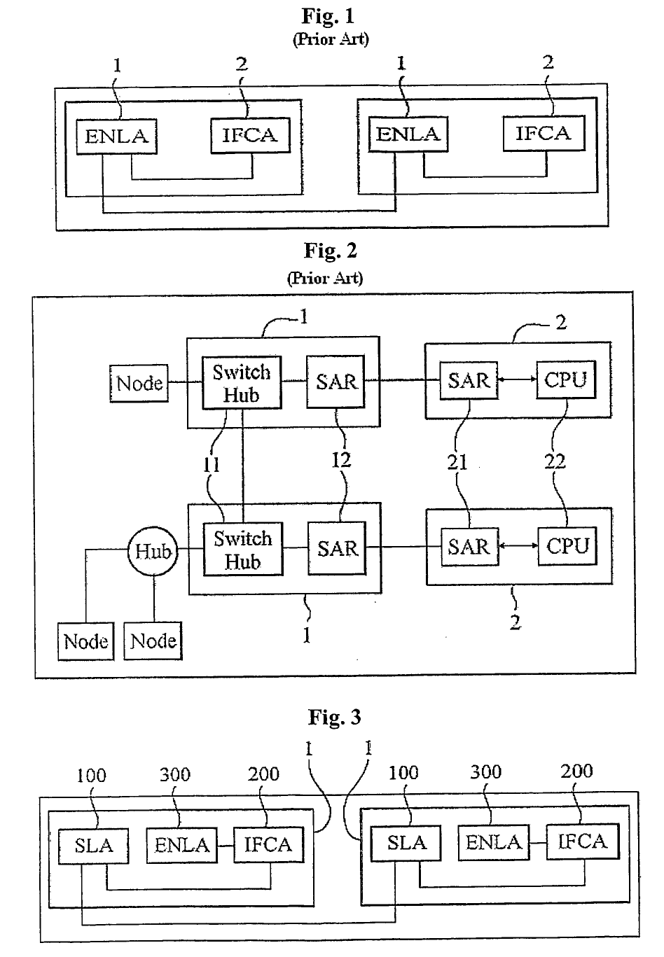

### BEST MODE FOR CARRYING OUT THE INVENTION

Hereinafter, a switch router according to one embodiment of the present invention will be described in detail with reference to the accompanying drawing.

FIG. 3 is a functional block diagram of the switch router for use in HAMS, which enables the transmission of IP packet data, according to one embodiment of the present invention. The switch router comprises Switch Link board Assembly (SLA) 100, IP Forwarding Control Assembly (IFCA) 200, and EtherNet Link board Assembly (ENLA) 300.

SLA 100 switches ATM packet data inputted from higher block 1 to IFCA 200. SLA 100 also switches the ATM packet data inputted from IFCA 200 to higher block 1.

IFCA 200 routes the ATM packet data inputted from SLA 100 to ENLA 300. IFCA 200 also routes the ATM packet data inputted from ENLA 300 to SLA 100.

ENLA 300 converts the ATM packet data routed from IFCA 200 to an Ethernet data and transmits the Ethernet data to higher block 1. ENLA 300 also converts the Ethernet data inputted from higher block 1 to a local ATM packet data and transmits the local ATM packet data to IFCA 200. Further, ENLA 300 manages the source MAC address, which is transferred form each higher block, as a table, and transmits the packet data to the packet's destination MAC address sent from IFCA 200.

The operations of the switch router for use in HAMS, which has the constitutions described above, will now be described with reference to FIG. 3.

The communication between some higher block (node) 1 and another higher block (node) 1 having network of another switch router will be described.

First, when the Ethernet data is inputted to ENLA 300 from higher block (node) 1, ENLA 300 converts the Ethernet data inputted from higher block (node) 1 to the local ATM packet data and transmits the local ATM packet data to IFCA 200. The ENLA 300 comprises a switching hub that may be connected to higher block (node) 1, a SAR that serves as a vocoder/devocoder, and a CPU that performs MAC switching. Therefore, the Ethernet data inputted from higher block (node) 1 is received by the switching hub, converted to the ATM packet data by the SAR, and then MAC switched to IFCA 200 by the CPU.

Then, IFCA 200 determines the head information of the ATM packet data inputted from ENLA 300 and transmits the ATM packet data to SLA 100. SLA 100 may be connected to a number of SLAs through a hub, and IFCA 200 determines the destination of the ATM packet data, which is outputted from SLA 100.

SLA 100 then transmits the ATM packet data to the other SLA 100. When communicating with higher block (node) 1, which processes the ATM packet data, SLA 100 is connected through the other SLA 100.

The other SLA 100 then transmits the inputted ATM packet data to the other IFCA 200. Then, the other IFCA 200 determines the head information of the inputted ATM packet data and routes the ATM packet data to the other ENLA 300. Accordingly, the other ENLA 300 converts the inputted ATM packet data to the Ethernet data and MAC switches the Ethernet data to the other higher block (node) 1.

The switch router of the present invention, which enables the transmission of IP packet data, provides a faster communication service compared to the conventional switch router, where LAN cable is used for connection. Also, the invention implements the controls for Ethernet data and ATM packet data independently to thereby facilitate adding additional functions.

The present invention is described with reference to the preferred embodiment and the drawing, but the description is not intended to limit the present invention to the form disclosed herein. It should also be understood that a person skilled in the art is capable of using a variety of modifications and other embodiments equal to the present invention. Therefore, only the appended claims are intended to limit the present invention.

### INDUSTRIAL APPLICABILITY

The switch router of the present invention enables the transmission of IP packet data and provides a faster communication service compared to the conventional switch router, where LAN cable is used for connection. Also, the invention implements the controls for Ethernet data and ATM packet data independently to thereby facilitate adding additional functions.

1. A switch router for transmitting IP packet data, comprising:
a Switch Link board Assembly (SLA) for switching an ATM packet data inputted from a higher block to an IP Forwarding Control Assembly (IFCA), the SLA further being operative to switch the ATM packet data inputted from the IFCA to the higher block;
an IFCA for routing the ATM packet data inputted from the SLA to an EtherNet Link board Assembly (ENLA), the IFCA further being operative to route the ATM packet data inputted from the ENLA to the SLA; and
an ENLA for converting the ATM packet data routed from the IFCA to an Ethernet data and transmitting the Ethernet data to the higher block, the ENLA further being operative to convert the Ethernet data inputted from the higher block to a local ATM packet data and outputting the local ATM packet data to the IFCA.

2. The switch router as claimed in claim 1, wherein the SLA, the IFCA and the ENLA are connected by fiber optic cable for use in ATM communication.
